(19) United States
(12) Patent Application Publication
(10) Pub. No.: US 2011/0303376 A1
(43) Pub. Date: Dec. 15, 2011

(54) IMIDIZED AND AMIDIZED ROSIN COMPOSITIONS FOR PAPER SIZES AND OTHER APPLICATIONS

(75) Inventors: Alan F. Nitzman, Pensacola, FL (US); Michael T. Huggins, Pensacola, FL (US); James D. Reeves, Pensacola, FL (US); A. Timothy Royappa, Pensacola, FL (US)

(73) Assignee: PLASMINE TECHNOLOGY, INC., Pensacola, FL (US)

(21) Appl. No.: 12/815,860

(22) Filed: Jun. 15, 2010

(51) Int. Cl. D21H 17/56; C08L 79/02; C08G 73/02

(52) U.S. Cl. 162/164.6; 525/54.42; 524/612

(57) ABSTRACT

Rosin is modified by maleation and then by imidization resulting in attaching a cationic polymer or cationic material upon the rosin. Alternatively, rosin can be fumarated and then cationic material attached by amide links. The products may be used for an efficient paper size and other applications of rosin products.

### BACKGROUND OF THE INVENTION

1. Technical Field

The invention relates to the field of modified rosins which contain a chemically bonded polymeric compound and methods of making such compounds. The rosin compounds can be used as sizing agents in the paper industry.

2. Description of the Background Art

Most grades of paper used for writing, printing, packaging and other uses are treated with a sizing agent. Sizing agents (sizes) increase the fluid resistance of paper or paperboard, usually to wetting by aqueous liquids such as water, inks, and the like.

Rosin is a complex mixture of natural products that has been known since ancient times. It remains a low-cost organic acid and is used today in paints, printing inks, toners, rubber chemicals, and as a paper size, among other uses. In general, rosin is purified from natural sources (for example, coniferous trees) and from products formed in the paper industry by fractionation or other means. Rosin is composed of tricyclic rosin acids (such as abietic acid, palustric acid, and neoabietic acid), fatty acids and unsaponifiables.

Paper has been sized using rosin and alum for about two hundred years now. For most of this time, rosin has been saponified, i.e., reacted with an alkali, to render it partly or completely soluble in water, although rosin in its free acid form is a more effective paper size. The rosin soap or rosin in free acid form then can be mixed with paper fibers and alum (aluminum sulfate), which acts to precipitate the rosin onto the fibers. Rosin modification to improve sizing compounds has been performed. For example, the rosin can be reacted with a dienophile to produce a tricarboxylic acid. An example of this type of reaction with maleic anhydride is shown in FIG. 1. The dienophiles most often employed in this process are fumaric acid and maleic anhydride, but other substances such as itaconic acid or maleic acid also can be used. The reaction products are known as fortified or reinforced rosins, which perform as paper sizes with more efficiency. See Casey, James P. (Ed.) Pulp and Paper Chemistry and Chemical Technology, 3rd. edition, vol. III, Wiley-Interscience, John Wiley & Sons, New
York, 1983.

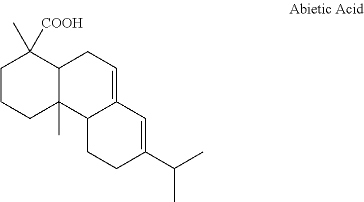

Today, dispersed rosin sizes, also called rosin size emulsions, are very important commercial products. Many in the industry divide rosin size emulsions into anionic and cationic types. Anionic rosin size emulsions have been described in for example, U.S. Pat. Nos. 1,882,680 and 3,865,769. Most anionic dispersions are stabilized with rosin alkali soaps and/or with casein. Casein, a milk protein, is amphoteric and has an isoelectric point of pH 4.6. Thus, casein is cationic at pH values below pH 4.6 and anionic above pH 4.6. Therefore, it is reasonable to assume rosin size emulsions stabilized with casein likewise are cationic at low pH and anionic at higher pH values. Techniques such as streaming potential measurements or zeta potential measurements measure net effect of charges on substances, and are commonly used to assess overall charge and to determine isoelectric points.

Cationic rosin size emulsions have been described in U.S. Pat. Nos. 3,966,654; 5,846,308 and 6,042,691. In this type of rosin emulsion, usually a cationic resin or combination of resins is mixed with rosin and emulsified. The cationic resins are cationic because of the presence of amine groups, which are believed to form salts with the carboxylic acid groups on the rosin. Attachment between the rosin and cationic resins also occurs because of hydrogen bonds and coordination bonds.

Modified rosin products also have been chemically modified by attaching nitrogen-containing compounds, such as by forming imides or various amines or amides with rosin and, for example, maleopimaric acid or oligomeric amines for use as paper sizes. U.S. Pat. No. 3,135,749 also describes imides of maleated rosin. None of the described compounds are imides of polymers and maleated rosin, however, and therefore they are distinct from the compounds of this invention. These compounds were designed for pharmacological uses such as to lower blood pressure and alleviate cardiac work load rather than paper sizing. Rosins modified with the addition of amines for paper sizing purposes have been prepared by reacting maleic anhydride and triethanolamine with rosin, which results in the attachment of the triethanolamine by ester bonds to maleated rosin. The resulting product can be emulsified with casein or with a special surfactant. U.S. Pat. Nos. 4,540,635 and 5,201,944 provide additional information on this subject.

Conventional rosin sizing of paper is, with a few exceptions, limited to acidic pH conditions due to the acidic characteristics of alum and the tendency of conventional sizes to perform poorly above a pH of about 6.5. The paper industry, however, has shifted to conditions closer to neutral pH because of the better permanence of paper under these conditions and the widespread use of calcium carbonate in paper-making. Conventional rosin sizes, however, have significantly decreased performance at these neutral pH conditions, so increasing amounts of size composition are needed to achieve the same result. This causes higher costs and may reduce paper quality and plant efficiency.

Most sizing performed under neutral pH conditions is achieved by synthetic sizes based on alkyl ketene dimers (AKD) or alkenyl succinic anhydride (ASA). These sizes generally are not compatible with aluminum sulfate and are more difficult to use. Rosin has been modified by esterification to protect it from saponification and render it more useful at pH values above 6.5, but sizes based on esterified rosin have met with very limited commercial success. Therefore, there remains a need in the art for affordable and convenient rosin size compositions which are effective under harsh conditions, i.e. pH above 6.5, and/or higher temperatures, i.e. temperatures above 50° C.

### SUMMARY OF THE INVENTION

Accordingly, embodiments of the invention provide a polymer-rosin compound of Formula I:

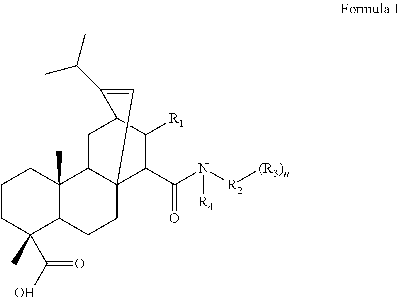

wherein R₁ is a hydrogen, carboxylic acid or a carbonyl which forms a 5-member hetero ring structure by covalent attachment to the nitrogen, wherein R₂ is a straight or branched C1-C3 alkyl group or is a single bond between the nitrogen and (R₃)ₙ, wherein R₃ is selected from the group consisting of alkane, alkene, aminoalkane, diaminoalkene, aminoalkene, diaminoalkene, arene (aromatic hydrocarbon), aminoarene, polyamine and a mixture thereof, wherein R₄ is absent or is selected from the group consisting of hydrogen, alkane and polyamine, and wherein n is an integer of at least 9. Preferably n is 9 to about 2500.

Preferred embodiments of the invention provide such polymer-rosin compounds wherein R₁ is a carbonyl which forms a 5-membered hetero ring structure by covalent attachment to the nitrogen (in which case R₄ is absent) or wherein R₁ is a carboxylic acid, and wherein n is about 400 to about 700, or about 500 to about 600. Additional preferred embodiments include such compounds wherein R₂ is a bond or a straight or branched C1-C3 alkyl group. Further preferred embodiments include such compounds wherein the polymer is straight or branched and is a homopolymer or a co-polymer. Most preferably, R₃ is polyethylenimine.

Preferred embodiments include polymer-rosin compounds wherein R₃ is present on about 1 to about 17% of the molecules of Formula I, more preferably about 1.5% to about 8% of the molecules of Formula I. In some embodiments, the polymer-rosin compounds include those wherein R₃ is present on about 3 to about 16% of the molecules of Formula I or about 3 to about 14% of the molecules of Formula I. Most preferred polymer-rosin compounds have about 2% to about 5% of the molecules of Formula I. Embodiments most preferred for use as a paper size generally have less than about 6% of the molecules of Formula I.

Most preferred compounds include Formula II:

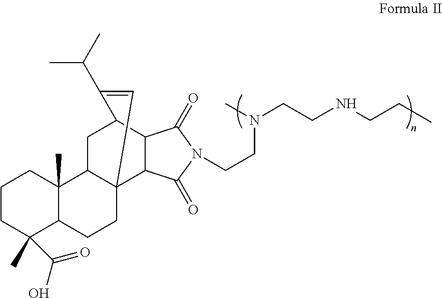

or Formula III:

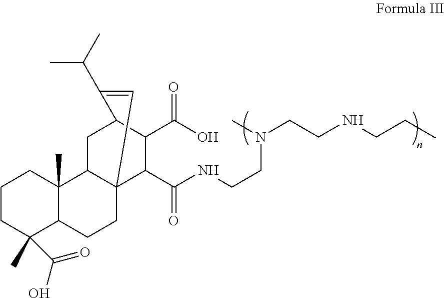

Additional embodiments of the invention include methods of making the polymer-rosin compounds described above which comprise reacting an at least partially fortified rosin compound, for example tall oil rosin or gum rosin, with a polyamine compound. The partially fortified rosins preferably are about 3% to about 16% or about 3% to about 14% fortified. Preferred fortified rosin compounds may be rosins selected from the group consisting of maleated rosin, fumarated rosin, itaconicated rosin, citraconicated rosin, acrylated rosin, methacrylated rosin and any combination thereof and preferred polyamine compounds are selected from the group consisting of polyethylenimine, polyaniline, poly(allyl amine), poly(oxyethylene/oxypropylene)diamine, O,O′-bis(2-aminopropyl) polypropylene glycol, and any combination thereof. In some preferred methods, the ratio of polyamine to rosin is about 1% to about 17% by weight, or more preferably about 1.5% to about 8% by weight and most preferably about 2% to about 5% by weight. For paper sizes the ratio of polyamine to rosin is less than 6%.

Additional embodiments of the invention include methods of making the polymer-rosin compounds as discussed above by (a) melting an at least partially fortified rosin in a reversibly sealable vessel that is equipped with an inlet attached to an inert gas source to allow entry of an inert gas atmosphere into said vessel and an outlet to allow exit of gases and water vapor from said vessel; (b) agitating said fortified rosin and maintaining said fortified rosin at a temperature of about 100° C. to about 300° C.; (c) providing a flowable polyamine compound; (d) dispensing said flowable polyamine compound into said fortified rosin; (e) reacting said polyamine and said fortified rosin by agitating said polyamine/fortified rosin mixture at a temperature of about 100° C. to about 300° C. to form an amide- or imide-linked polymer-rosin compound; (f) cooling said polymer-rosin compound; and (g) optionally storing said polymer-rosin compound in a sealed container. Preferably, at least the reaction is conducted in an inert atmosphere and is conducted at a temperature of about 125° C. to about 250° C., about 150° C. to about 240° C. or about 170° C. to about 230° C., and preferably in the absence of solvent. Preferably, the at least partially fortified rosin is about 3% to about 16% fortified or about 3% to about 14% fortified.

In some embodiments of the methods, the polyamine compound is selected from the group consisting of polyaniline, poly(allyl amine), poly(oxyethylene/oxypropylene) diamine, O,O′-bis(2-aminopropyl)polypropylene glycol, polyethylenimine, and any combination thereof, most preferably polyethylenimine. The ratio of polyamine to rosin advantageously is about 1% to about 17% by weight, preferably about 1.5% to about 8% by weight and most preferably about 2% to about 5% by weight. The reaction preferably is conducted for about 2 hours.

Embodiments of the invention also include polymer-rosin compounds made by any of the methods discussed above.

Further embodiments of the invention include a polymer-rosin dispersion composition comprising a polymer-rosin compound as discussed above, water and a surfactant. and a paper or paperboard product which has been treated with this polymer-rosin dispersion composition.

### BRIEF DESCRIPTION OF THE DRAWINGS

FIG. 1 shows an example of a chemical reaction suitable for producing a fortified rosin (maleic anhydride tall oil rosin (MATOR)).

FIG. 2 is an infrared spectrum of the modified rosin product of Example 1, and shows the formation of an imide linkage.

FIG. 3 is an infrared spectrum showing amide formation in an exemplary fumarated rosin adduct with polyethylenimine.

FIG. 4 is a graph showing the variation of softening point with addition of alpha olefin wax to MATOR modified with 10% LupasolWF™.

FIG. 5 is a graph showing the acid number of modified rosin compositions made by reacting varying amounts of PEI with 13.6% MATOR.

FIG. 6 is a graph showing the softening point of modified rosin compositions made by reacting varying amounts of PEI with 13.6% MATOR.

FIG. 7 is an exemplary IR spectrum of 13.6% MATOR.

FIG. 8 is an IR spectrum of 12% PEI on 11% MATOR.

FIG. 9 shows the chemical reaction of MATOR with PEI to form a modified rosin product. n=an integer of at least 9.

FIG. 10 shows the chemical structure of the reacted product of FTOR (fumarated tall oil rosin) with PEI. n=an integer of at least 9.

FIG. 11 shows the chemical structures of exemplary acidic compounds useful for making the fortified rosin compounds for reaction with the inventive methods and the resulting fortified rosin compounds as indicated. 11A (maleic anhydride); 11B (fumaric acid); 11C (itaconic anhydride); 11D (methacrylic acid); 11E (itaconic anhydride rosin adduct with PEI); 11F (methacrylic acid rosin adduct with PEI).

### DETAILED DESCRIPTION OF THE PREFERRED EMBODIMENTS

In accordance with embodiments of the present invention, this specification discloses modified rosin products, which are useful in the paper industry and for other purposes, and a method of making such products. Methods of using the products to size paper also are disclosed. Other uses for the products of the invention include inks, toners, adhesives, and the like. See for example U.S. Pat. Nos. 6,200,372; 7,671,144, 7,501,468 and 4,612,273 and U.S. Patent Publication No. 2005-0143488, the disclosures of which are incorporated by reference, for discussion and examples of uses for rosin products which are suitable for the present invention.

Preferred embodiments of the invention involve a rosin-based sizing agent where fortified rosin is modified by chemical attachment of a cationic resin (polymer). The chemical attachment results in an imide or amide linkage between carboxylic acid groups on the rosin and amine groups on the polymer resin which are stable with respect to temperature so that the rosin will not become saponified under conditions found in paper-making in a paper mill. Preferred compounds are the products of fumarated or maleated rosin and polyethylenimine (PEI).

Embodiments of the invention involve compounds with an attachment of a polymer amine via imide and/or amide linkages to acid groups on rosin, as well as compositions, including emulsions and dispersions, containing these compounds and methods of making the compositions. Products made with these compounds and compositions also form part of the invention. Preferred compounds have about 1% to about 17% or about 1.5% to about 8% polymer relative to the weight of rosin, and most preferably about 2% to about 5% polymer. Preferred compounds which are to be used as sizes in the paper industry contain less than about 6% polymer to avoid rendering the composition too hydrophilic for effective paper sizing, because the polymer is hydrophilic, and most preferably about 2% to about 5%.

Rosin is derived from natural sources and is a complex material. Rosins (also known as colophony) useful in this invention include tall oil rosin (TOR), gum rosin, wood rosin or any other convenient form of colophony or mixture thereof, in a crude or refined state. Modified rosins such as disproportionated and dimerized rosins also may be employed. Partially hydrogenated or polymerized rosins also may be used, as well as rosins that have been treated to inhibit crystallization, such as with formaldehyde.

The preferred rosin useful in the invention is fortified tall oil or gum rosin, or a mixture thereof, optionally mixed with additional unfortified rosin(s). However, any convenient commercially available type of rosin may be used. Most preferably, the fortified rosin is the adduct reaction product of appropriate structures (abietic, palustric and neoabietic acids, for example) on the tall oil rosin and an alpha-beta-unsaturated organic acid or anhydride such as fumaric acid, maleic acid, acrylic acid, methacrylic acid, itaconic acid, citraconic acid, maleic anhydride, itaconic anhydride, citraconic anhydride and mixtures of these compounds or any known method of rosin fortification. These compounds are referred to herein as “acidic compounds.” Preferred acidic compounds for reaction with the rosin are fumaric acid and/or maleic anhydride. It is understood that in a fortified rosin product not every rosin molecule is reacted, resulting in a mixture of reacted and non-reacted rosin molecules.

The fortified rosin products useful for the invention preferably are produced with about 3% to about 16% acidic compound by weight of rosin, or about 3% to about 14% acidic compound by weight of rosin, however any convenient commercially available fortified rosin also may be used. Preferred ranges are 3%-16% when the acidic compound is fumaric acid and 3%-14% when the acidic compound is maleic anhydride.

Suitable polymer amines for use with the invention include any polymer amine compound which can react as described below with acidic groups on rosin or fortified rosin to result in an imide or amide linkage, for example polyaniline, poly(allyl amine), poly(oxyethylene/oxypropylene) diamine (CAS no. 65605-36-9), O,O′-bis(2-aminopropyl)polypropylene glycol (CAS no. 9046-10-0), or polyethylenimine. Preferred polymers contain little or no water. The most preferred polyamine is polyethyleneimine (PEI), such as Lupasol WF™ (water-free PEI).

As used herein, the term “polymer” and its cognates, with reference to polyamine compounds useful with the invention, indicates a compound with more than 8 monomers, whereas the term “oligomer” refers to compounds having 8 or fewer monomer units. The polymeric amine compounds useful in the invention include polymers having more than 8 monomer units or at least 9 monomer units, at least 10 monomer units, at least 12 monomer units, at least 20 monomer units, at least 25 monomer units or at least 30-50 monomer units. Preferred polyamines are compounds with 9 monomer units to about 2500 monomer units, or more preferably about 50 monomer units to about 1000 monomer units. Most preferred polyamines have at least about 400 monomer units to about 750 monomer units or about 500-600 monomer units. Depending on the molecular weight of the monomer unit, the preferred molecular weight of the polyamine compound generally is about 300 or more atomic mass units (amu) or about 350 amu to about 90,000 amu. Most preferred polyamines have a molecular weight of at least about 16,000 amu to about 37,000 amu or about 40,000 amu, for example about 20,000 amu to about 30,000 amu or about 25,000 amu. As is known in the art, polymers generally are characterized by average molecular weight rather than a precise molecular weight. Therefore, the monomer unit number and the molecular weight ranges discussed above are estimates of the averages of the polymer compounds, and variations from these ranges are contemplated for use with the invention.

Polymers useful with the invention for paper sizes or other uses in general have a molecular weight and size which allow them to melt or flow at the temperatures normally found in manufacturing, i.e. at the temperature of use. Therefore, depending on the particular process being used, the person of skill in the art can choose a polymer size/molecular weight suitable for the conditions. Thus, any suitable polymer having this functional characteristic are contemplated for use with the invention. In paper manufacturing, conditions can range, but generally are near about 105° C., for example, therefore the polymer compounds used should be able to melt and flow at this temperature.

Amine polymers containing primary and secondary amines may be used in the invention, however primary amines in general are more reactive and only primary amines can form imides. Tertiary amines are not suitable to provide amide or imide linkages but may be included in the reaction mixture.

Polyethylenimine at an average molecular weight of about 25,000 is the preferred polyamine. It preferably is used in the reaction as discussed below at about 1% to about 17% by weight relative to the rosin, most preferably about 2% to about 5%.

This invention also relates to rosin compositions such as emulsions and dispersions of rosin, including such compositions that are highly effective sizing agents for paper. The dispersions can either be anionic or cationic in charge, and are more stable and more effective paper size agents compared to conventional dispersed sizes made with just fortified rosin or with other commonly modified rosins such as rosin esters.

To make embodiments of the products of this invention, cationic materials are chemically attached to rosin, forming imides and/or amides which are thermally stable and otherwise resistant to decomposition under all application conditions used in paper mills. The size compositions are particularly suited to use under harsh conditions, for example neutral pH (above pH 6.5) and at higher than normal temperatures.

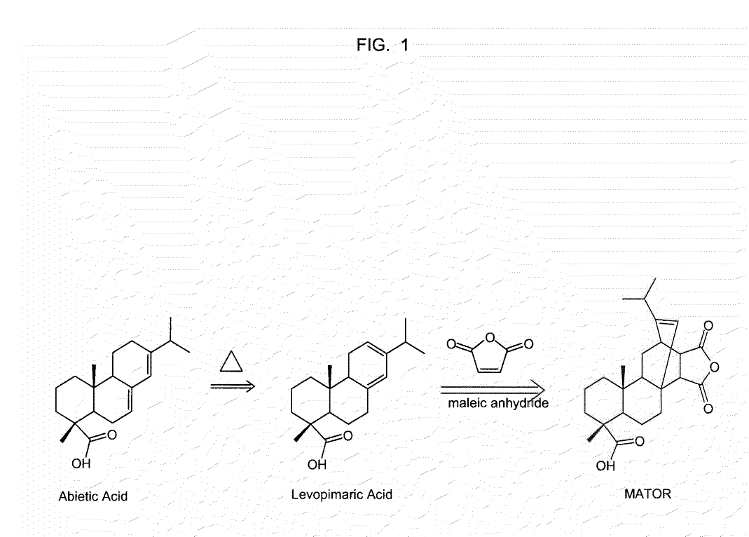

Commerically available fortified rosins containing added acid groups may be purchased or prepared. Fortified rosins also may be mixed with non-fortified rosins for use with the invention. Esterified rosin also may be used as part of the mixture. The preferred rosin is a maleated tall oil or gum rosin or a fumarated tall oil or gum rosin, or mixtures thereof. Fortified rosin can be made by any convenient method as known in the art. In general, any method known in the art is suitable, including any method referenced here. The formation of Diels-Alder adducts of rosin is known per se. Heating abietic acid, for example, causes the conjugated bonds to change places; maleation then occurs through a Diels-Alder mechanism. See the reaction, which is shown in FIG. 1, for example.

To produce rosin compounds according to embodiments of the invention, fortified rosin or a mixture of fortified rosin and unfortified rosin is melted at a temperature of about 100° C. to about 300° C. as is suitable for the rosin being used, or preferably at a temperature of about 170° C. to about 220° C. or about 200° C. and held with agitation to ensure uniformity and complete melting. Approximately 2 hours, for example, generally is sufficient. The container for conducting the reaction preferably is equipped with a nitrogen flow system which can maintain an inert atmosphere in the container and assist in venting undesired gases, such as water vapor (steam) which is produced during the reaction or oxygen, however any suitable inert gas can be used for this purpose. A scrubber system also may be included and is preferred. Preferably, the reaction is carried out at a temperature of about 100° C. to about 300° C. or any convenient temperature depending on the melting points of the reactants. More preferably, the reaction is conducted at about 125° C. to about 250° C. or about 150° C. to about 240° C. and most preferably about 170° C. to about 220° C. No solvent is used, and in particular addition of water preferably is avoided as far as possible.

The reaction preferably is carried out in an inert atmosphere or any non- or limited-oxygen-containing gas, to prevent oxygen from becoming involved in the reaction. Any inert gas can be used, such as argon, helium or nitrogen, however nitrogen generally is more convenient and less expensive. Water also preferably is avoided during the reaction. Therefore, the reaction should be carried out in a vessel equipped with a mechanism for venting gases such as oxygen and water vapor prior to and during the reaction. Most preferably the flow of inert gas is fast enough to remove oxygen and water as it is formed by the reaction.

Once the rosin has been melted and the atmosphere of the vessel inerted, the polyamine compound is added to the rosin, having been melted, if necessary. The compound preferably is added in small batches or very gradually, since water is produced by the reaction and preferably is not allowed to build up in the reaction vessel, but is vented from the system as the reaction proceeds, with sufficient agitation to mix the rosin and amine, but not so violent an agitation to increase bubble formation and foaming.

The polyamine compound can be added over a period of about 15 minutes up to about 7 hours. In most cases a period of about 30 minutes to about 120 minutes, preferably about 30 to about 90 minutes, and most preferably about 60 minutes. The reaction is allowed to proceed, with agitation, while maintaining the reaction vessel at the desired reaction temperature until the reaction has proceeded to the degree necessary, for example for about 30 minutes or more, preferably for about 45 minutes to about 6 hours, or about 60 minutes to 4 hours. The reaction mixture is cooled to stop the reaction, and the product then may be used or stored in a sealed container for later use. The length of the total reaction time depends on the formulation, with times ranging in most cases from about 30 minutes to more than 3 hours. Persons of skill will be able to determine the appropriate time to allow the reaction to go to completion by observation, for example of evolution of water vapor (steam), from the reaction mixture. Infrared spectrum analysis can be used to characterize the rosin adducts to confirm that the reaction has taken place and the degree of reaction that has occurred by detecting the loss of the anhydride carbonyl signal and the appearance of imide carbonyl stretches.

The stoichiometry of the reaction can be important in some embodiments of the inventive method of reaction. For example, an excess of anhydride groups is preferred if only imides are desired in reactions involving the polyamine compound(s) or, for example, polyethylenimine (PEI). When using PEI, amide bonds also can form even though anhydride groups are not in large excess. The chemical reaction between the maleated or fumarated rosin and the polyamine(s) optionally may be carried out with the use of an acid catalyst.

As discussed above, compounds, such as PEI, which contain primary, secondary, and tertiary amines (in the approximate ratio of 1:1:0.75 in the case of some commercial preparations of PEI) will react primarily on the primary amines in the formation of imides and amides, and tertiary amines will not react at all. These considerations will affect the ratios of compounds used in the reaction.

The process used to produce dispersions in this patent preferably is the inversion process, also referred to as the Bewoid process. Several different emulsification methods may be used, however, or any convenient method known in the art. If appropriate, the inversion process may be used, either batch or continuous processes. One distinct advantage of the continuous process is that materials with very high softening points can be emulsified. Other common techniques involve the use of a homogenizer. Either a solvent may be used with a homogenizer or higher temperatures and pressures using only water. Because of cost and environmental concerns, a nonsolvent process is preferred for commercial purposes, but a solvent process is convenient for the laboratory.

Dispersed rosin compositions according to embodiments of the invention generally contain about 40% to about 80% water and about 58% to about 17% rosin compound, and are emulsified using known emulsifying agents such as casein, cationic starch, alkali salts of sulfonated nonylphenol ethoxylates, sodium lauryl sulfate, or any appropriate emulsifying agent, preferably in amounts of about 0.3% to about 8% of the total composition. Preferred rosin size dispersions contain approximately 60% water, approximately 37% rosin size compound according to the invention and approximately 3% emulsifying agents. Small amounts of defoamer (up to about 800 ppm of a 20% solution of silicon polymers, for example) and/or biocide (about 600 ppm dazomet, for example) optionally also may be added. The person of skill is aware of compounds which may be added to benefit the final product. Such products also are contemplated as part of the invention. In addition, any carrier or other product can be added depending on the use to which the product is to be put, as is known in the art.

Preferred compounds and compositions according to embodiments of the invention are used as sizing agents for paper and paperboard. The sizes can be used according to known methods in the industry. In general the rosin composition is an aqueous dispersion which is mixed with paper pulp, and the pulp is thereafter formed into paper. Two factors important in judging the quality of a size product are the sizing effect and size stability. The Hercules Size Test can be used to measure size performance. This test measures the change in reflectance of the paper surface during penetration of a standard aqueous solution of dye from the opposite face of the paper sheet. The end point of the test is the time to reach a convenient degree of reduction in reflectance, for example 10% or 20%. Longer times indicate better sizing performance for the paper product.

The preferred compounds of the invention are useful as a paper size that can be used conveniently at neutral pH ranges, yet be effective as a size. The compositions can be used as internal or external (surface) sizes. Very high quality dispersions of the products, the preferred dispersions for use as paper sizes, were made with about 1% to about 5% PEI on about 3% to about 16% MATOR. Additional compounds include about 1% to about 17% PEI on about 83% to about 99% maleated or fumarated rosin. The modified rosin compounds of the invention may be blended with additives to adjust the softening point as is convenient. Suitable additives include wax, mineral oil and the like. Reactive materials such as ASA may also be used as additives. The inventive products also may be mixed with esterified rosin compounds for use as paper sizing compositions.

Considering the widespread use of rosin amines, rosin imides and the like in inks and toners, and in adhesives, the products discussed in this patent also have utility in these other application fields.

The following non-limiting examples provide illustrations of the manufacture and use of compounds according to the invention.

### EXAMPLES

### Examples 1-19

### Preparation of Rosin Reaction Products

A one liter resin kettle was equipped with a nitrogen feed and outlet, a temperature control probe, an agitator, a water-cooled condenser and receiver, and a stopper which could be removed for addition of ingredients. The agitator was outfitted with two blades: a radial blade on top and an axial blade on bottom. The agitator shaft was fixed so that the bottom blade was in the middle of the mixture, and the top blade was only halfway immersed. A heating mantle with attached temperature control was used to heat the mixture. The nitrogen flow was maintained at a level sufficient to reduce oxygen levels in the reaction vessel so that oxidation of the MATOR was minimal and the water produced in the reaction was carried out of the resin kettle.

Six hundred grams of solid MATOR chunks (made with 11.8% maleic anhydride by weight relative to the weight of rosin) were added to the resin kettle. The MATOR was melted and brought to a temperature of 200° C., with agitation. Polyethyleneimine homopolymer (Lupasol WF™, BASF Corp., CAS No. 9002-98-6), also referred to as aziridine homopolymer, was heated in a large syringe and kept in an oven at 70° C. to maintain the polymer as a liquid. A total amount of 18 g PEI was dispensed from the syringe in a thin stream to the molten MATOR, in portions. The final ratio of PEI/MATOR was 3% by weight. After approximately 3 g of PEI (Lupasol WF™ (Lutensol™), average molecular weight 25,000) was added, the amount dispensed, temperature, and appearance of the mixture were noted and agitation continued. Another portion of PEI was added and observations again were noted. Periodically, the syringe was returned to the oven briefly to keep the PEI free-flowing. The temperature of the reaction vessel was held at approximately 200° C., and the mixture was agitated until it appeared completely translucent, homogeneous, and bubble and foam free. Total reaction time was about 1 hour. The mixture was poured from the kettle into an aluminum tray for cooling, sealed in a plastic bag, and stored.

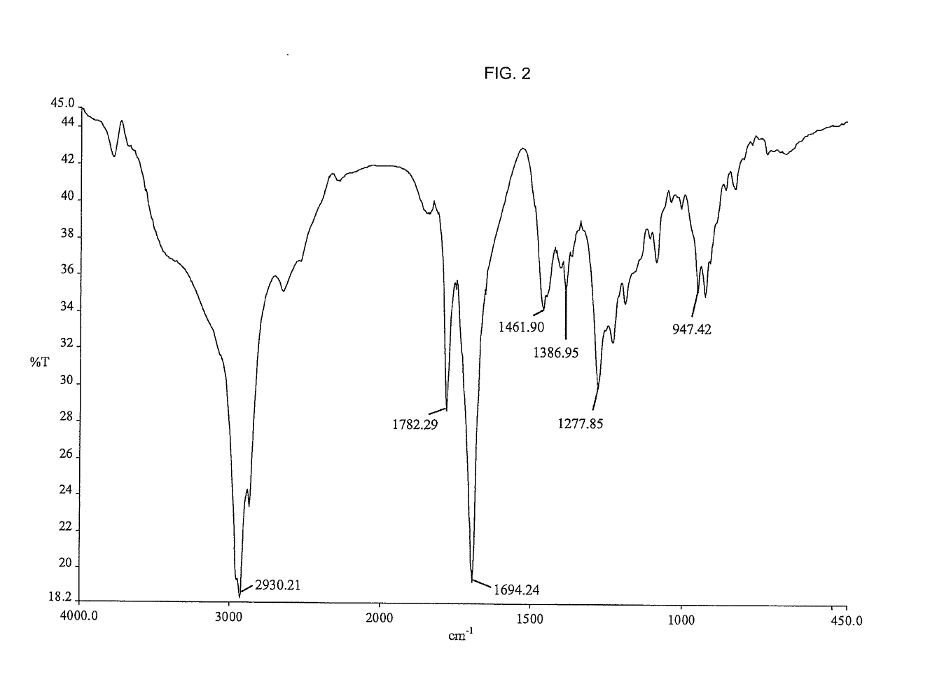

In order to confirm that the reaction had occurred and an imide was produced, the product was subjected to infrared (IR) spectrum analysis. The loss of the anhydride carbonyl signal and the appearance of the imide carbonyl stretches in the infrared spectrum indicated a successful reaction. The IR spectrum of the finished product is shown in FIG. 2. Changes in the softening point and acid numbers also confirmed a successful reaction. Final properties of the product formed are listed in Table I, below. The acid number was determined by ASTM Method D465-96, using toluene and ethyl alcohol. Note that this method underestimates anhydride groups in known ways.

This synthetic method was repeated successfully on a large scale in plant production equipment. The rosin reaction was repeated according to Example 1, above, in Examples 2-19, with changes in the ratio of maleic anhydride to rosin used in the production of the MATOR and the ratios of PEI:MATOR. The specifics are listed below in Table I, with properties of the final products.

The tall oil resin used to make the MATOR in Examples 16-18 was analyzed by gas chromatography to quantitate the amount of palustric, neoabietic and abietic acids in the starting compound. The results showed that there were sufficient amounts of these acids (which are conjugated) to allow as much as 16% maleic anhydride to be adducted in the Diels-Alder reaction. Lupasol G20™ (CAS no. 25987-06-8) is a copolymer of 1,2-ethanediamine with aziridine and is a more linear polymer than Lupasol WF™ (Example 19).

TABLE I
Properties of Modified Rosins.

| | | | wt % | wt % | Soften- | |
|---|---|---|---|---|---|---|
| Exam- | | | Acidic | Amine | ing | Acid |
| ple | | | Com- | Com- | Point | Number |
| Number | Rosin | Amine | pound | pound | (° C.) | (mg/g) |
| 1 | MATOR | Lupasol | 11.8 | 3 | 114.9 | 195.1 |
| | | WF ™ | | | | |
| 2 | MATOR | Lupasol | 13.6 | 1 | 110.4 | 209.9 |
| | | WF ™ | | | | |
| 3 | MATOR | Lupasol | 13.6 | 2 | 114.1 | 204.4 |
| | | WF ™ | | | | |
| 4 | MATOR | Lupasol | 13.6 | 3 | 117.1 | 198.8 |
| | | WF ™ | | | | |
| 5 | MATOR | Lupasol | 13.6 | 4 | 126.8 | 194.5 |
| | | WF ™ | | | | |
| 6 | MATOR | Lupasol | 13.6 | 6 | 130.9 | 174.6 |
| | | WF ™ | | | | |
| 7 | MATOR | Lupasol | 13.6 | 10 | 146.2 | 138.2 |
| | | WF ™ | | | | |
| 8 | MATOR | Lupasol | 13.6 | 12 | 150.5 | 127 |
| | | WF ™ | | | | |
| 9 | MATOR | Lupasol | 13.6 | 14 | 156.6 | ND* |
| | | WF ™ | | | | |
| 10 | MATOR | Lupasol | 13.6 | 15 | 147.2 | 127 |
| | | WF ™ | | | | |
| 11 | MATOR | Lupasol | 3 | 3 | 98 | 166.4 |
| | | WF ™ | | | | |
| 12 | MATOR | Lupasol | 3 | 4 | 117.5 | 177.9 |
| | | WF ™ | | | | |
| 13 | MATOR | Lupasol | 6 | 3 | 101.6 | 168.9 |
| | | WF ™ | | | | |
| 14 | MATOR | Lupasol | 6 | 6 | 111.5 | 145.3 |
| | | WF ™ | | | | |
| 15 | MATOR | Lupasol | 11 | 4 | 118.9 | 172.7 |
| | | WF ™ | | | | |
| 16 | MATOR | Lupasol | 16 | 4 | 125.9 | 173.4 |
| | | WF ™ | | | | |
| 17 | MATOR | Lupasol | 16 | 10 | 153.1 | 132 |
| | | WF ™ | | | | |
| 18 | MATOR | Lupasol | 16 | 17 | 147.2 | 130.7 |
| | | WF ™ | | | | |
| 19 | MATOR | Lupasol | 13.6 | 6 | 133.5 | 172.8 |
| | | G20 ™ | | | | |

*ND = could not determine

### Examples 20-31

### Preparation of Rosin Reaction Products

The rosin reaction was repeated as described in the Examples above, with the specifics indicated in Table II, below, using the liquid (non-polymer) amines as indicated. Because the amines were liquid, there was no need to heat the syringe used to add the amine. The ratios of amine to MATOR and characteristics of the final products are as listed below.

TABLE II
Properties of Modified Rosins.

| | | | wt % | wt % | Soften- | |
|---|---|---|---|---|---|---|
| Exam- | | | Acidic | Amine | ing | Acid |
| ple | | | Com- | Com- | Point | Number |
| Number | Rosin | Amine | pound | pound | (° C.) | (mg/g) |
| 20 | MATOR | tert-butyl | 13.6 | 14 | 105.6 | 156.3 |
| | | amine | | | | |
| 21 | MATOR | 3-dimethyl | 13.6 | 14 | 105.5 | 136.2 |
| | | aminopropyl | | | | |
| | | amine | | | | |
| 22 | MATOR | n-butyl | 13.6 | 13.6 | 76 | 135.9 |
| | | amine | | | | |
| 23 | MATOR | n-butyl | 13.6 | 14 | 84.6 | 136.9 |
| | | amine | | | | |
| 24 | MATOR | ethanol | 13.6 | 13.6 | 76.5 | 133.1 |
| | | amine | | | | |
| 25 | MATOR | diethyl | 13.6 | 14 | 101.8 | 207.7 |
| | | amine | | | | |
| 26 | MATOR | dibutyl | 13.6 | 14 | 82.9 | 165 |
| | | amine | | | | |
| 27 | MATOR | 1,6-diamino | 13.6 | 14 | 124.3 | 121.7 |
| | | hexane | | | | |
| 28 | MATOR | propylamine | 13.6 | 13.6 | 81.8 | 137.2 |
| 29 | MATOR | aniline | 13.6 | 14 | ND* | ND* |

*ND = could not determine

### Example 30

### Rosin Adducts with Triethanolamine

In Example 30, rosin resin was prepared as described for Examples 21-30, but following the disclosures of U.S. Pat. No. 4,540,653, using triethanolamine as the amine. Triethanolamine is a tertiary amine, and the reaction produces an ester linkage, and therefore not an imide or an amide. The ratio of triethanolamine:MATOR was 8%.

TABLE III
Properties of Triethanolamine Rosin Adduct.

| | | | wt % | wt % | Soften- | |
|---|---|---|---|---|---|---|
| Exam- | | | Acidic | Amine | ing | Acid |
| ple | | | Com- | Com- | Point | Number |
| Number | Rosin | Amine | pound | pound | (° C.) | (mg/g) |
| 30 | MATOR | trietha- | 11.8 | 8 | 112.5 | 142.6 |
| | | nolamine | | | | |

### Example 31

### Fumarated Rosin Adduct with Polyethylenimine

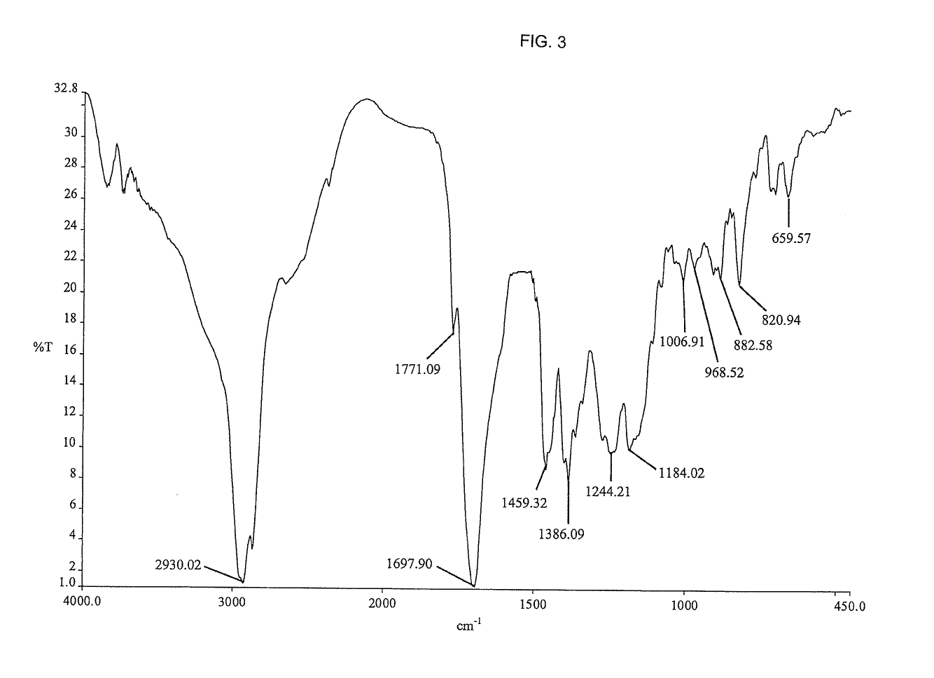

The rosin reaction again was repeated, using the method described in Example 1 above, except that fumarated rosin (prepared with 8% fumaric acid relative to rosin) was used in place of maleated rosin and the reaction temperature was 220° C. The ratio of PEI:fumarated rosin was 2%. Amides are formed in this reaction; imides cannot form. An IR spectrum of this product is shown in FIG. 3.

TABLE IV
Properties of Fumarated Tall Oil Rosin-PEI Adduct.

| | | | wt % | wt % | Soften- | |
|---|---|---|---|---|---|---|
| Exam- | | | Acidic | Amine | ing | Acid |
| ple | | | Com- | Com- | Point | Number |
| Number | Rosin | Amine | pound | pound | (° C.) | (mg/g) |
| 31 | FTOR | Lupasol | 8 | 2 | 108.1 | 193 |
| | | WF ™ | | | | |

### Example 32

### Emulsification of Rosin Adducts

The modified rosin product of Example 1 was emulsified using an inversion process. The modified rosin resin (187 g) was placed in a round bottom flask fitted with a stirrer and heated well above its softening point (i.e., above 115° C.). The melted resin was agitated, and an aqueous solution of potassium hydroxide (2.5 g of 45% KOH) was added slowly to the flask. The amount of the base was sufficient to saponify a few percent of the rosin.

Casein dispersion was prepared separately by dispersing 7.4 g casein in 72.5 g of water with agitation and heat, and by raising the pH with 1.3 g potassium hydroxide to about pH 10.5. Then, 13.5 g of a 22% aqueous solution of a cationic polyacrylamide (Nalsize™ 7541) was mixed into the casein dispersion to result in 5.7% casein-polyacrylamide on rosin. This casein-polyacrylamide dispersion was added to the resin slowly. Then, 52.1 g water at 65° C. was added to this mixture, which inverts from a water-in-oil type emulsion to an oil-in-water emulsion during this water addition. Additional water, about 156.4 g (at room temperature) was added until the final desired concentration was reached (final concentration 40%). The process by which the emulsion was formed is described in U.S. Patent Publication 2009/0298975, and in particular example 6 of that patent application. Biocides and defoamers may be added as desired to the emulsion. See Table VI below for emulsion properties of the rosin dispersions.

### Example 33

### Emulsion of Rosin Adducts

Emulsions were prepared as described in Example 32 using the rosin products of Examples 4, 6, 12, 14, 15, 30 and 31, with different amounts of KOH added. See Table V, below.

TABLE V
Emulsion Preparations.

| Example | 45% KOH | | Amine |
|---|---|---|---|
| Number | (g) | Rosin | Compound |
| 4 | 2.9 | 13.6% | 3% PEI |
| | | MATOR | |
| 6 | 1.8 | 13.6% | 6% PEI |
| | | MATOR | |
| 12 | 0.1 | 3% | 4% PEI |
| | | MATOR | |
| 14 | 1.8 | 6% | 6% PEI |
| | | MATOR | |
| 15 | 1.4 | 11% | 4% PEI |
| | | MATOR | |
| 30 | 2.1 | 13.6% | 8% TEA |
| | | MATOR | |
| 31 | 1.0 | 8% | 2% PEI |
| | | FTOR | |

The compound of Example 6 was modified from this description as follows. One part alpha olefin wax was added to nine parts rosin to lower the softening point from 130.9° C., which generally is considered too high for good paper sizing under standard conditions of paper manufacturing. Products that had melting points so high that simultaneous stirring and water addition was not possible could not be emulsified using this method. Also, compounds that had so few acid groups that casein (which preferentially operates as a surfactant at a pH close to 6.20) did not effectively act as a surfactant or compounds for which KOH addition resulted in salt formation, or both, could not be emulsified with this method. These compounds were not considered suitable for use as paper sizing agents in an anionic dispersion of this type without further processing or blending, but can be used in other industries.

### Example 34

### Effect of Addition of Wax to Rosin Emulsion

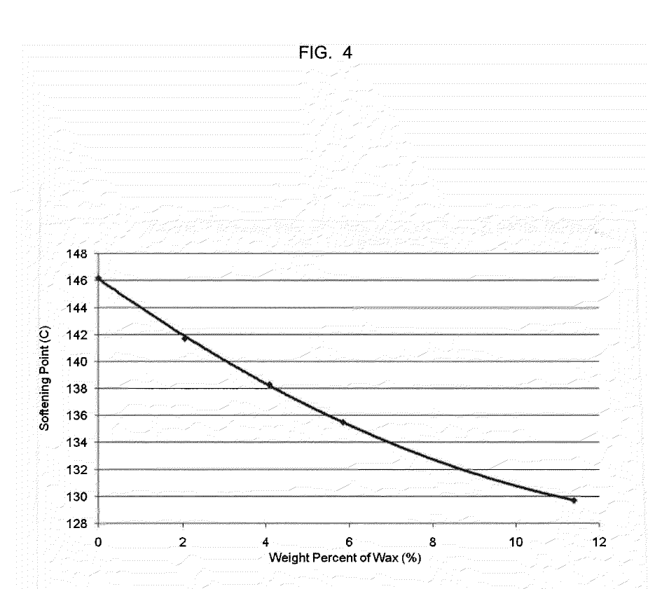

The effect of addition of wax to the rosin product of Example 7 is shown in FIG. 4. Wax lowers the softening point.

### Example 35

### Emulsification of Rosin Adducts by Homogenization

The modified rosin compounds of Examples 1 and 20 were emulsified by homogenization. The modified rosin (208.7 parts) was dissolved in 139.1 parts methylene chloride solvent. Separately, an aqueous phase was prepared by adding 27.8 parts of Sta-lok™ 140 starch (an cationic waxy corn starch) and 3.5 parts of Ufoxane™ 2 sodium lignosulphonate (a lignin-based surfactant) to 650 parts water and cooking for 90 minutes at 93 to 95° C., and then cooling to room temperature. The aqueous and solvent phases then were blended together in a blender at low speed for two minutes. The mixture was homogenized in two passes in a Manton Gaulin™ homogenizer, model 15MR, at 7000 psig. The solvent then was stripped off at atmospheric pressure, and the dispersion cooled. See Table VI, below, for results.

### Example 36

### Emulsification of Rosin Adduct by Homogenization without an Exogenous Emulsifying Agent

The modified rosin prepared in Example 18 (220.6 parts) was dissolved in 147.1 parts methylene chloride solvent. Separately, an aqueous phase was prepared by adding 8.9 parts of 88% aqueous formic acid to 505.9 parts water. The aqueous and solvent phases were blended together in a blender at low speed for two minutes. The mixture then was homogenized in two passes in a Manton Gaulin™ homogenizer, model 15MR, at 7000 psig. The solvent then was stripped off at atmospheric pressure, and the dispersion cooled. As shown in Table VI, this process resulted in a stable emulsion without using any other exogenous emulsifying agent. Without wishing to be bound by theory, it is believed that the hydrophilic amine groups in the PEI/MATOR stabilized the emulsion, but that the high level of PEI produced a highly hydrophilic product that could produce light sizing. It is possible that changes in pH might cause the product to be more attracted to the paper fibers, resulting in a greater level of size.

TABLE VI
Emulsion Properties of Selected Examples.

| | Total Solids | | Viscosity | Particle Size | |
|---|---|---|---|---|---|
| Examples | (%) | Fall Out (%) | (cp) | (μm) | pH |
| 1, 32 | 40.1 | 3.1 | 13 | 0.774 | 5.9 |
| 4, 33 | 39.9 | 2.0 | ND | 0.588 | 6.4 |
| 6, 33 | 40.2 | 8.9 | ND | ND | 6.8 |
| 12, 33 | 37.2 | 8.9 | ND | 1.134 | 6.6 |
| 14, 33 | 39.1 | 20 | ND | ND | 7.5 |
| 15, 33 | 40.7 | 3.2 | ND | 1.078 | 6.7 |
| 30, 33 | 40.7 | 5.3 | 37 | 0.432 | 6.3 |
| 31, 33 | 42.2 | 5.6 | 91 | 1.070 | 6.2 |
| 1, 35 | 27.7 | 1.6 | 20 | 0.664 | 4.7 |
| 20, 35 | 26.7 | 1.6 | 19.4 | 0.974 | 6.3 |
| 18, 36 | 29.0 | 2.8 | 7.6 | 0.514 | 3.4 |

ND = not done

Emulsion properties reported in Table VI include total solids, fall out, viscosity, particle size and pH. Fall out is the amount of sediment accumulated on the bottom of a centrifuge tube after spinning a 50 g sample at approximately 1000×g for one half hour, pouring off the supernatant, rinsing the residue lightly with water and drying the residue at 105° C. for three hours. The fall out is reported as a percentage of the dispersion solids. Viscosity measurements were made using a Brookfield™ model DV-I+, using spindle LV 1. Particle sizes were measured on a Coulter™ LS 13 320, Laser Diffraction Particle Size Analyzer, Beckman Coulter™, Inc. Median values were tabulated.

### Example 37

### Testing Results on Modified Rosin Compositions

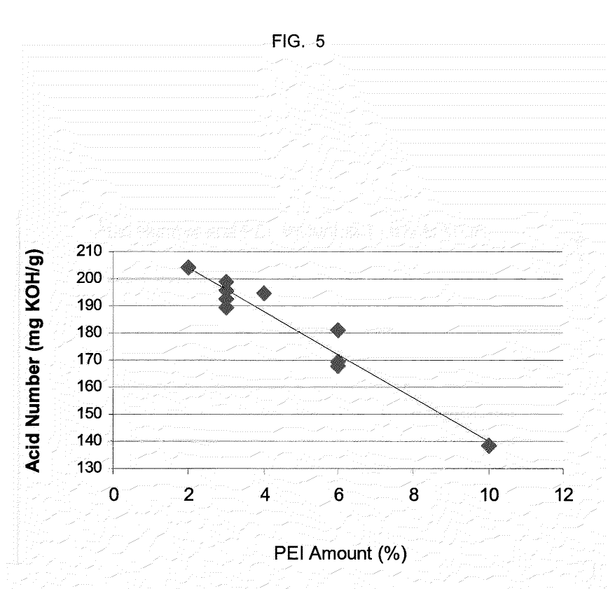

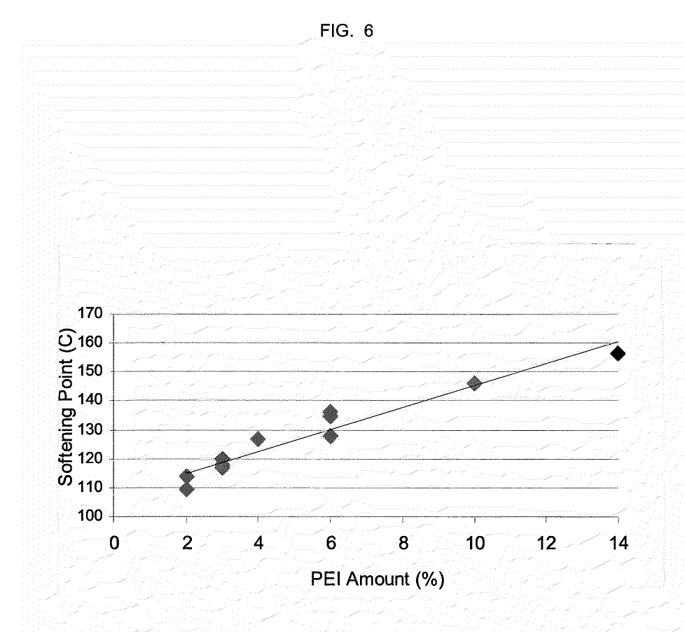

Modified rosin compounds made using 13.6% MATOR and varying amounts of PEI were tested by infrared spectroscopy, nuclear magnetic resonance, melting point, softening point (ball and ring method), acid number (the value in mg KOH/g sample that measures acid groups present in a compound), and mass spectroscopy. The test results showed that softening point increases with the amount of PEI fortification and with the amount of maleic fortification. The acid number of MATOR decreases as it reacts with PEI because the reaction consumes carboxylic acid groups in fortified abietic acid. The acid number values were determined by dissolving the compound in a mixture of toluene and ethanol, titrating the solution with NaOH, and calculating the number of acid groups present in the compound from the titration end point. The data are shown in FIG. 5. This acid number underestimates the true number of acid groups because the maleic anhydride groups of the compound react with ethanol, forming an ester. As a consequence, the slope of the line representing the data should be steeper. See FIG. 5 for data relating to acid number and FIG. 6 for data relating to softening point.

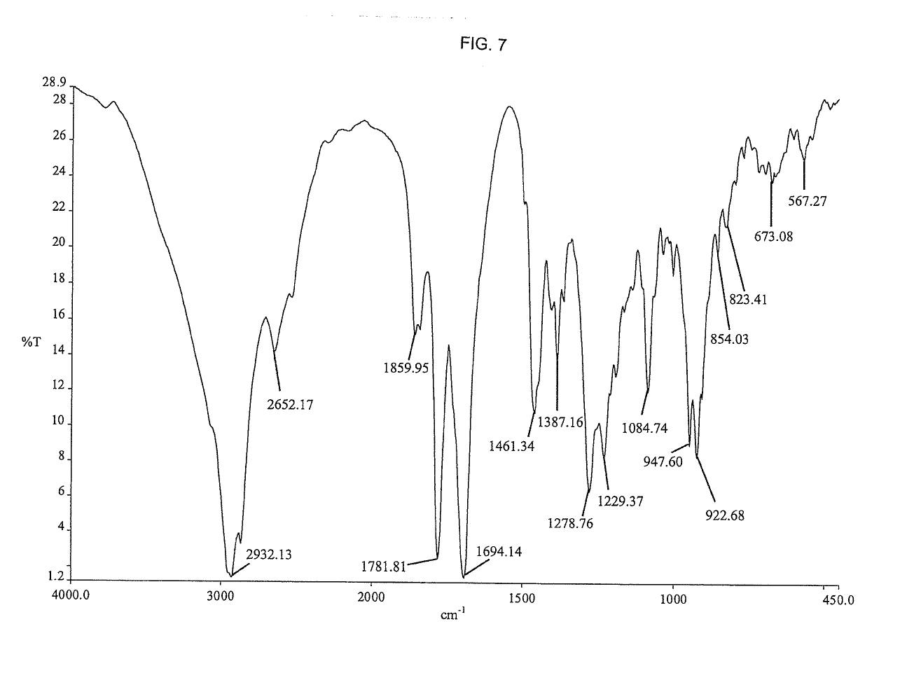

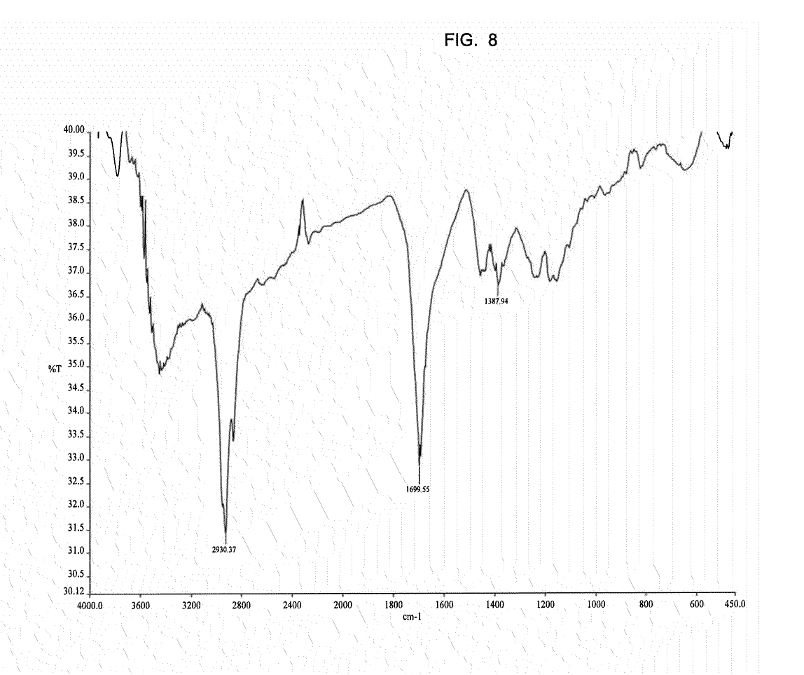

Infrared (IR) spectra were taken of the starting MATOR and the final reacted product to verify that the procedures did cause the reaction to go to completion. An exemplary IR spectrum of 13.6% MATOR is shown in FIG. 7. Comparing this Figure to FIGS. 8 and 2, which show the IR spectra of 12% PEI reacted with 11% MATOR and 3% PEI on 11.8% MATOR, respectively, one can see that the peak at 1780 cm⁻¹ (the anhydride carbonyl) disappears as the reaction proceeds. When equimolar amounts of PEI and MATOR are reacted (approximately 12% PEI on 11% MATOR, for example), the peak should be gone entirely. In FIG. 2, the anhydride carbonyl peak is present, but smaller than in FIG. 7. In FIG. 8, the anhydride carbonyl peak has completely disappeared.

### Example 38

### Confirmation of Diels-Alder Adduct Formation Using a Model Compound

Pure abietic acid was used as a model for rosin to test the feasibility of the reaction. Abietic acid was reacted with maleic anhydride in a Diels-Alder reaction to form the anhydride product. Formation of the product was confirmed by the loss of one of the alkene protons in the proton Nuclear Magnetic Resonance spectrum (¹H-NMR) (the peak at approximately 5.4 ppm disappears), an increase in M+H peak (401 m/z) in the mass spectrum, and the addition of new C═O peaks in the IR spectrum (1750-1770 cm-1). The resulting Diels-Alder adduct then was reacted with a stoichiometric amount of 4-bromoaniline, a solid amine, to give the imide product.

The imide was characterized by the M+H peak at 554 m/z by mass spectrometry, addition of the aryl CH protons (7.0 and 7.8 ppm) in the 1H-NMR, and the loss of the anhydride C═O peaks in the IR spectrum. New imide C═O peaks appear in the 1700-1780 cm-1 region. No amide peak was seen in the mass spectroscopy results. The IR spectrum of the model compound was essentially identical to the PEI-maleated rosin adduct in the C═O region which confirmed this as the product in the PEI-rosin reaction. The IR spectrum also was well comparable to the IR spectrum of a similar imide, 2,5-pyrrolidinedione, CAS number 123-56-8.

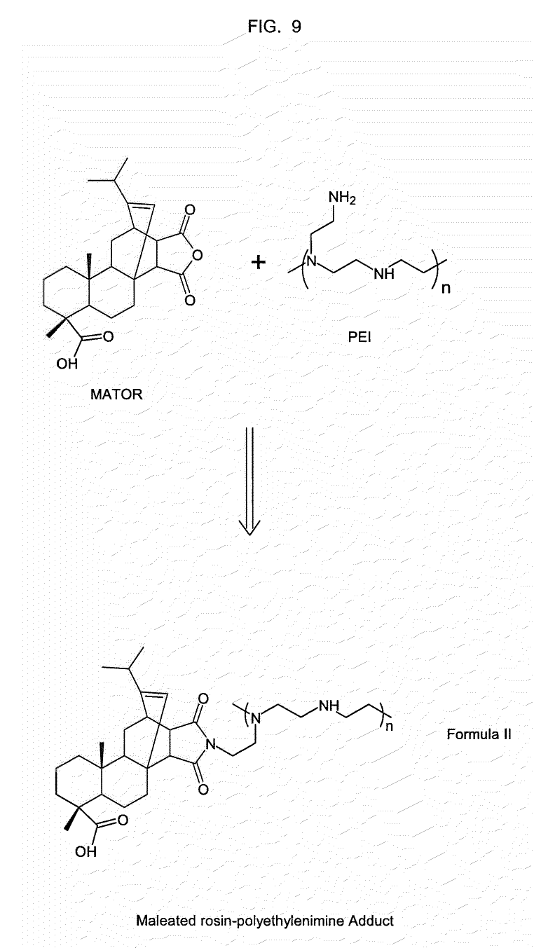

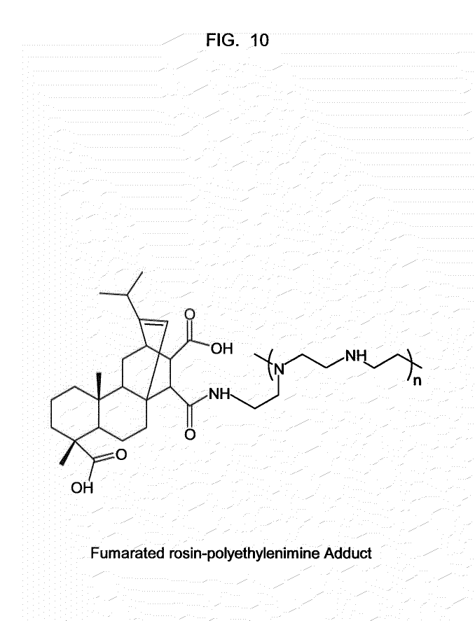

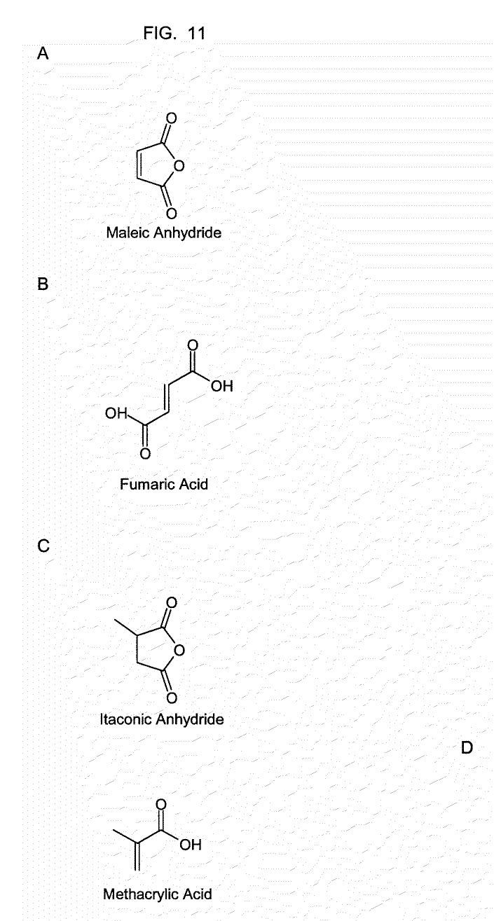

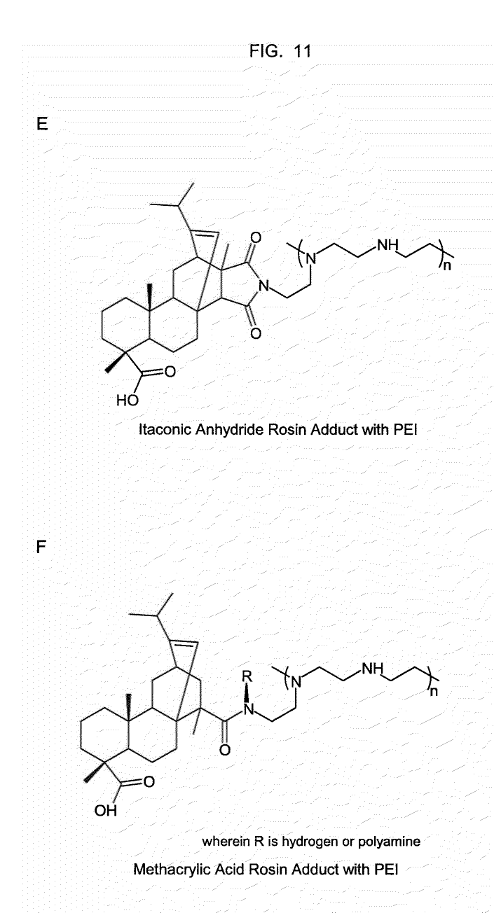

These tests show that an imide linkage is formed by the reaction. See FIG. 9 for the chemical reaction of MATOR and PEI. FIG. 10 provides the structure of the analogous product made using fumarated tall oil rosin (FTOR). The imide group is less acidic than the carboxylic acid group it replaces, and is more stable. Because the imide is more stable, the rosin products made in this way are more stable, for example in use as a paper size under conditions found in paper manufacture, even at high temperatures and high pH. This results in an effective size that forms fewer depositions under manufacturing conditions. See FIG. 11 for structures of additional exemplary acidic compounds and fortified rosin compositions which are useful with the inventive methods.

### Example 39

### Paper Sizing

Hand sheets were prepared for testing of sizing. Procedures for their production generally conform to Tappi test method T 205 with some exceptions. Briefly, pulp (a mixture of 85% bleached, kraft hardwood and 15% bleached, kraft softwood, with a Canadian Standard Freeness (CSF) of 350 mL) was added to a cup. Water was maintained at 55° C. and adjusted to 135 ppm hardness using CaCl₂. The water was added to the pulp and agitation begun. Within seconds, the pH was adjusted with dilute NaOH. After one minute, alum (8 lb/ton of pulp) and the size composition (5 lb/ton of pulp) were added. The alum basis (defined according to the common practice in the paper industry as “dry” alum) was Al₂(SO₄)₃.14H₂O (average 14 waters of hydration). At the 90 second mark, 3 lb/ton cationic starch (UltraCharge™ 340) was added. At 2 minutes, 0.5 lb/ton colloidal silica (Eka™ NP442) was added. At 3 minutes, the sheet was formed, then pressed once for one minute at 60 psig. Drying was performed in a laboratory drum drier for 2.5 minutes at approximately 115° C.

Results of a Hercules Sizing Test (HST), using Naphthol Green B dye with 1% formic acid ink at 80% reflectance, for four different sizes, are shown in Table VII. A commercially available size composition was used as a control. The data show that Example 1,32 is a highly efficient size at the near-neutral pH of 6.7. Example 1, 35 is less efficient, but significantly better than the standard commercially available size NeuRoz™ 426. Example 20,35 was produced with a non-polymer amine, tert-butyl amine.

TABLE VII
Sizing Results, bleached pulp.

| Example Number | HST (sec) |
|---|---|
| 1, 32 | 40.5 |
| 1, 35 | 19.5 |
| 20, 35 | 2.4 |
| NeuRoz ™ 426 | 7.6 |

### Example 40

### Paper Sizing

The method described in Example 39 was repeated except that the starch used was cationic starch Cato™ 232. Results of the Hercules Sizing Test for the indicated examples and commercially available sizes are shown in Table VIII.

TABLE VIII
Sizing Results, bleached pulp.

| Example Number | HST (sec) |
|---|---|
| 1, 32 | 61.4 |
| 31, 33 | 102.9 |
| NeuRoz ™ 426 | 31.5 |
| NeuRoz ™ 540 | 41.7 |

### Example 41

### Paper Sizing Tests

Example 40 was repeated with the products indicated in Table IX. These data show that the most efficient size is Example 4,33. Examples 12,33 and 15,33 also perform well compared to the commercial products. Examples 6,33 and 14,33 appear to contain too many hydrophilic groups for optimal and efficient paper sizing.

TABLE IX
Sizing Results, bleached pulp.

| Example Number | HST (sec) |
|---|---|
| 4, 33 | 138.7 |
| 6, 33 | 0.3 |
| 12, 33 | 63.8 |
| 14, 33 | 1.4 |
| 15, 33 | 96.0 |
| NeuRoz ™ 426 | 26.0 |
| NeuRoz ™ 540 | 43.0 |

### Example 42

### Paper Sizing

This example shows sizing of paper with unbleached instead of bleached pulp. The method described in Example 39 was repeated except that the starch used was cationic starch Cato™ 232 and no colloidal silica was added. In addition, alum was used at 6 lb/ton and 4 lb/ton size was added. The pulp was virgin unbleached kraft (UBK) softwood with a CSF of 380 ml. The results of the Hercules Sizing Test are shown in Table X. The size produced in Example 1, emulsified according to Example 32 was most efficient. The least efficient is Example 30,33, which comprises rosin prepared by prior art methods.

TABLE X
Paper Sizing, UBK Pulp.

| Example Number | HST (sec) |
|---|---|
| 1, 32 | 430 |
| 30, 33 | 33 |
| 1, 35 | 119 |
| NeuRoz ™ 426 | 87 |
| NeuRoz ™ 540 | 158 |

### Example 43

### Deposition Testing

A lower tendency to deposit on surfaces in paper mills is an important attribute in paper sizes for use in commercial paper mills. Deposition tests were performed in order to compare the amount of rosin size depositing on the pulp for selected rosin size products according to the invention compared to a current commercial product. This test was modified from a test developed by Allen and Filion, Tappi J. 79:226, 1996. Mill pulp was adjusted in solids to 15% and raised to pH 7, a level that promotes deposition. The pulp was heated, and kept at a constant temperature of 60° C., with stirring, in a heavy duty mixer for 1 hour. Plates attached to the stirring element were weighed before and after the test. Eight pounds of size per dry pound of pulp was added. The average weight increases are reported in Table XI, and show a lower deposition for the inventive product than either of the commercially available sizes. Without wishing to be bound by theory, it is possible that this result is due to a stronger attachment of the inventive product to the fiber and/or better protection of acid groups from saponification in the inventive product.

TABLE XI
Deposition Testing Results.

| Example | Average Weight |
|---|---|
| Number | Gain (mg) |
| 1, 32 | 4.8 |
| NeuRoz ™ 426 | 6.5 |
| NeuRoz ™ 540 | 5.5 |

### Example 44

### Testing of Electrokinetic Properties

The zeta potential is a measure the potential difference between a dispersion medium and the stationary layer of fluid attached to the dispersed particle. In the paper industry, the zeta potential is used to measure the electrokinetic potential in the colloidal system of a sizing product. The zeta potentials of a rosin product according to the invention was tested at the indicated pHs for comparison to two commercially available dispersed rosin sizes manufactured by Plasmine Technology™, Inc. At the pH values normally encountered in paper mills using dispersed rosin sizes (about pH 4.5 to pH 6.5), NeuRoz 540 is an anionic size, prepared from fortified rosin; NeuRoz 426 is a cationic size, also prepared from fortified rosin. However, as the data in Table XII show, when the pH is raised, the sizes change character. The testing was performed using a Zeta-potential and Particle Size Analyzer ELSZ-2 (Photal Otsuka Electronics™ Co., Ltd.).

TABLE XII
Zeta Potentials of Dispersed Rosin Sizes.

| | Zeta Potential (mV) | | |
|---|---|---|---|
| pH | Example 32 | NeuRoz ™ 540 | NeuRoz ™ 426 |
| 4.1 | +27.4 | +12.7 | +25.5 |
| 5.9 | −12.7 | −25.2 | +30.5 |
| 7.9 | −37.2 | −37.2 | −18.9 |
| 9.9 | −34.2 | −39.2 | −36.6 |

1. A polymer-rosin compound of Formula I: 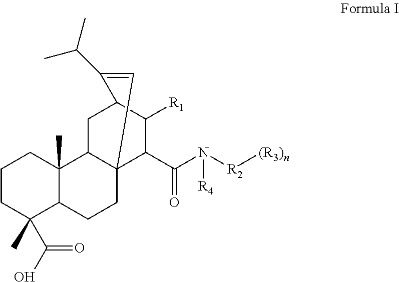
wherein R₁ is a hydrogen, carboxylic acid or a carbonyl which forms a 5-member hetero ring structure by covalent attachment to the nitrogen,
wherein R₂ is a straight or branched C1-C3 alkyl group or is a single bond between the nitrogen and (R₃)ₙ,
wherein R₃ is selected from the group consisting of alkane, alkene, aminoalkane, diaminoalkane, aminoalkene, diaminoalkene, arene, aminoarene, polyamine and a mixture thereof,
wherein R4 is absent or is selected from the group consisting of hydrogen, alkane and polyamine, and
wherein n is an integer of at least 9.

2. The polymer-rosin compound of claim 1, wherein R₁ is a carbonyl which forms a 5-membered hetero ring structure by covalent attachment to the nitrogen.

3. The polymer-rosin compound of claim 1, wherein R₁ is a carboxylic acid.

4. The polymer rosin compound of claim 1, wherein n is 9 to about 2500.

5. The polymer-rosin compound of claim 1, wherein n is about 400 to about 700.

6. The polymer-rosin compound of claim 5, wherein n is about 500 to about 600.

7. The polymer-rosin compound of claim 1, wherein R₂ is a bond.

8. The polymer-rosin compound of claim 1, wherein R₂ is a straight or branched C1-C3 alkyl group.

9. The polymer-rosin compound of claim 1, wherein said polymer is straight or branched.

10. The polymer-rosin compound of claim 1, wherein said polymer is a homopolymer.

11. The polymer-rosin compound of claim 1, wherein said polymer is a co-polymer.

12. The polymer-rosin compound of claim 1, wherein R₃ is polyethylenimine.

13. The polymer-rosin compound of claim 1, wherein R₃ is present on about 1 to about 17% of the molecules of Formula I.

14. The polymer-rosin compound of claim 1, wherein R₃ is present on about 1.5% to about 8% of the molecules of Formula I.

15. The polymer-rosin compound of claim 1, wherein R₃ is present on about 3 to about 16% of the molecules of Formula I.

16. The polymer-rosin compound of claim 1, wherein R₃ is present on about 3 to about 14% of the molecules of Formula I.

17. The polymer-rosin compound of claim 1, wherein R₃ is present on about 2% to about 5% of the molecules of Formula I.

18. The polymer-rosin compound of claim 1, wherein R₃ is present on less than about 6% of the molecules of Formula I.

19. The polymer-rosin compound of claim 1, which is Formula II:

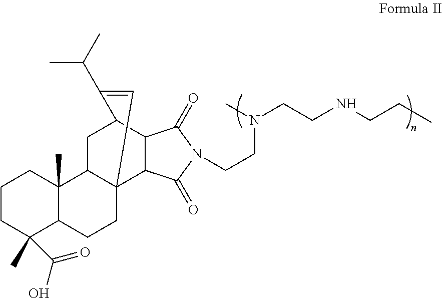

20. The polymer-rosin compound of claim 1, which is Formula III:

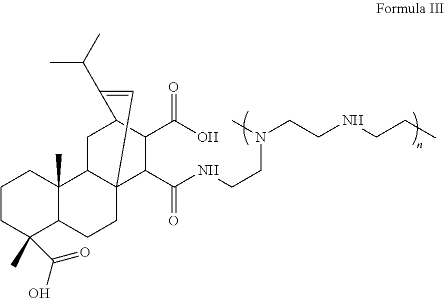

21. A method of making the polymer-rosin compound of claim 1 which comprises reacting an at least partially fortified rosin compound with a polyamine compound.

22. A method of claim 21, wherein said rosin is about 3% to about 16% fortified.

23. A method of claim 21, wherein said rosin is about 3% to about 14% fortified.

24. The method of claim 21, wherein said rosin is tall oil rosin or gum rosin.

25. The method of claim 21, wherein said fortified rosin compound comprises a rosin selected from the group consisting of maleated rosin, fumarated rosin, itaconicated rosin, citraconicated rosin, acrylated rosin, methacrylated rosin and any combination thereof.

26. The method of claim 21, wherein said polyamine compound is selected from the group consisting of polyethylenimine, polyaniline, poly(allyl amine), poly(oxyethylene/oxypropylene)diamine, O,O′-bis(2-aminopropyl)polypropylene glycol, and any combination thereof.

27. The method of claim 21, wherein the ratio of polyamine to rosin is about 1% to about 17% by weight.

28. The method of claim 21, wherein the ratio of polyamine to rosin is about 1.5% to about 8% by weight.

29. The method of claim 21, wherein the ratio of polyamine to rosin is about 2% to about 5% by weight.

30. A method of making the polymer-rosin compound of claim 1 which comprises:
(a) melting an at least partially fortified rosin in a reversibly sealable vessel that is equipped with an inlet attached to an inert gas source to allow entry of an inert gas atmosphere into said vessel and an outlet to allow exit of gases and water vapor from said vessel;
(b) agitating said fortified rosin and maintaining said fortified rosin at a temperature of about 100° C. to about 300° C.;
(c) providing a flowable polyamine compound;
(d) dispensing said flowable polyamine compound into said melted fortified rosin;
(e) reacting said polyamine and said fortified rosin by agitating said polyamine/fortified rosin mixture at a temperature of about 100° C. to about 300° C. to form an amide- or imide-linked polymer-rosin compound of claim 1;
(f) cooling said polymer-rosin compound; and
(g) optionally storing said polymer-rosin compound in a sealed container;
wherein at least said reacting is conducted in an inert atmosphere.

31. A method of claim 30, wherein said fortified rosin is about 3% to about 16% fortified.

32. A method of claim 30, wherein said fortified rosin is about 3% to about 14% fortified.

33. The method of claim 30, wherein said reacting is conducted at about 125° C. to about 250° C.

34. The method of claim 30, wherein said reacting is conducted at about 150° C. to about 240° C.

35. The method of claim 30, wherein said reacting is conducted at about 170° C. to about 230° C.

36. The method of claim 30, wherein said reacting is conducted in the absence of solvent.

37. The method of claim 30, wherein said polyamine compound is selected from the group consisting of polyaniline, poly(allyl amine), poly(oxyethylene/oxypropylene)diamine, O,O′-bis(2-aminopropyl)polypropylene glycol, polyethylenimine, and any combination thereof.

38. The method of claim 37, wherein said polyamine compound is polyethylenimine.

39. The method of claim 30, wherein the ratio of polyamine to rosin is about 1% to about 17% by weight.

40. The method of claim 30, wherein the ratio of polyamine to rosin is about 1.5% to about 8% by weight.

41. The method of claim 30, wherein the ratio of polyamine to rosin is about 2% to about 5% by weight.

42. The method of claim 30, wherein said reacting is conducted for about 2 hours.

43. A polymer-rosin compound made by the method of claim 21.

44. A polymer-rosin compound made by the method of claim 30.

45. A polymer-rosin composition comprising the polymer-rosin compound of claim 1.

46. A polymer-rosin dispersion composition comprising the polymer-rosin compound of claim 1, water and a surfactant.

47. A paper or paperboard product which has been treated with the polymer-rosin dispersion composition of claim 46.
